(19) United States
(12) Patent Application Publication
(10) Pub. No.: US 2007/0209997 A1
(43) Pub. Date: Sep. 13, 2007

(54) Continuous flow biosolids stabilization

(76) Inventor: John R. Poppe, Silverdale, WA (US)

Correspondence Address: STEVEN P. KODA;KODA LAW OFFICE, 19689 - 7TH AVE NE, NO. 307, POULSBO, WA, 98370, US

(21) Appl. No.: 11/372,518

(22) Filed: Mar. 10, 2006

(51) Int. Cl. C02F 11/02; C02F 3/00; C02F 11/12

(52) U.S. Cl. 210/605; 210/612; 210/175; 210/603; 210/614

(57) ABSTRACT

A continuous flow wastewater treatment process is implemented for stabilizing biosolids. Sludge from a mesophyllic digester flows through heat exchangers to raise the temperature to a pasteurization temperature. The raised temperature sludge is flowed continuously through a detention tank from an input to an output, wherein sludge at the input and at the output is within the pasteurization temperature range. The sludge is maintained at the elevated temperature during the flowing for a prescribed time to stabilize the sludge. After said flowing, the sludge may be further digested in a mesophyllic digester, then separated into at least stabilized biosolids and effluent.

### FIELD OF THE INVENTION

The present invention generally relates to domestic and industrial waste water and sewage treatment systems and processes, and more particularly to a system and method for producing exceptional quality biosolids.

### BACKGROUND OF THE INVENTION

Wastewater treatment systems vary from natural bodies of water to sophisticated industrial and municipal treatment systems. Within populated areas, waste generated in homes, commercial establishments, and industry typically is collected and treated at an industrial or municipal wastewater treatment facility. The objective of wastewater treatment is to remove solids from the water (i.e., water pollution), often referred to as sludge.

Wastewater treatment generally is classified as primary, secondary, and tertiary treatment. Primary treatment includes processes that rely on physical processes (settling or skimming) to remove a percentage of organic and inorganic solids from wastewater, and processes that include flocculating agents that urge minute particles to coalesce into floc, (i.e., an agglomeration of smaller particles in a gelatinous mass having the feature of being more easily removed from the liquid than the individual small particles). With the aid of flocculating agents, primary treatment processes may eliminate 50% or more of the suspended solids.

Secondary treatment includes processes that rely on the primary treatment process and biological action to remove (and digest) fine suspended solids, dispersed solids, and dissolved organic solids. For example, anaerobic digestion is included in a secondary treatment process in which biochemical decomposition of organic matter occurs by bacterial organisms. Secondary processes may produce activated sludge including micro-organisms, nonliving organic matter and inorganic materials.

Tertiary or advanced wastewater treatment includes processes that primarily rely on chemical treatment and filtration equipment to reduce nutrients (phosphorous and nitrogen), organic matter, and residual solids and pathogens.

Stabilization of the solids being removed from wastewater is desired to allow the solids to be released and reused, for example, as a soil conditioner. The common methods of sludge stabilization in industrial nations include composting, digestion and incineration. There are various digestion processes. One type of digestion process is aerobic digestion, in which bacteria digest wastewater solids using oxygen. Another type of digestion is anaerobic digestion, in which bacteria digest wastewater solids without using oxygen. There are three categories of anaerobic digestion. Psyclophyllic digestion is anaerobic digestion occurring at temperatures below 65° F. Mesophyllic digestion is anaerobic digestion occurring in the temperature range between 90° F. and 110° F., (approximately 20° C. to approximately 35° C.). Thermophyllic digestion is anaerobic digestion occurring in the temperature range between 110° F. and 140° F.

Once wastewater solids (i.e., sludge) have been digested, they are referred to as biosolids. Biosolids are regulated in the United States and elsewhere to determine the conditions under which biosolids can be used in agriculture, silviculture, and natural soil enhancement (e.g., fertilizer).

The output of the various treatment processes generally includes biosolids, water effluent, and biogas (i.e., generally a mixture of methane and carbon dioxide). Biosolids are the stabilized solid, semi-solid and liquid residue of the waste water treatment process. Disposal of biosolids is regulated at the national level. For example, in the United States there are federal regulations classifying biosolids, and how the various classes of biosolids may be disposed. In the United States biosolids also are regulated at the state level.

For example, anaerobic digesters operating under mesophyllic conditions typically produce class B biosolids. The class B biosolids may be hauled away to a landfill, incinerated or used as a soil amendment that limits public access for three months or more. However, in the United States, the National Institute of Occupational Safety and Health (NIOSH) classifies Class B biosolids as a biohazard. Alternatively, some treatment systems may compost or lagoon the class B biosolids to produce class A biosolids—“exceptional quality” biosolids.

Exceptional quality biosolids is a specific term used by the U.S. Environmental Protection Agency (EPA) and the Water Environment Federation (WEF) to describe those wastewater solids that meet state and federal regulations, so as to be considered safe for recycling. These nutrient-rich organic by-products may be recycled as fertilizer and applied as a soil amendment to improve and maintain productive soils and stimulate plant growth. For example, 40 CFR 503 of the United States Code of Federal Regulations provides pathogen and vector attraction reduction requirements for biosolids. The 503 rule (i) identifies “Exceptional Quality” biosolids, (ii) encourages municipal wastewater treatment facilities to treat biosolids to a higher quality level so as to minimize constraints on use, and (iii) requires certain pollution control equipment and/or management practices to promote clean and safe uses for biosolids. Biosolids of “exceptional quality” are those that meet Class A pathogen reduction requirements, stringent heavy metals limits (pollutant concentrations) and vector attraction control requirements.

The objective of the EPA section 503 regulation is to promote processes which reduce pathogens to very low levels so as to render negligible the risk of infection and disease from the recycled biosolids material. Also, the amended soil environment where the recycled biosolids are applied generally adds some safety assurances. Specifically, the residual pathogens are expected to adhere to the amended soil. The pathogens, thus, may be effectively immobilized preventing the pathogens from entering the groundwater, and keeping them near the surface of the soil. Other soil conditions, such as exposure to sunlight, relative lack of moisture, freezing temperatures, and naturally occurring enemy microbes, may then destroy such residual pathogens.

It is a challenge for treatment facilities to produce exceptional quality biosolids. Conventional treatment processes, such as composting, are slow and costly. Yet, production and disposal of less than exceptional quality ‘biohazard’ biosolids through landfilling and incineration have drawbacks as well. Further, as populations in municipalities grow, the raw sewage in need of processing increases. Accordingly, there is a need for an effective, efficient treatment process for producing exceptional quality biosolids.

### SUMMARY OF THE INVENTION

The present invention provides a continuous flow wastewater treatment process for stabilizing biosolids. Sludge from a mesophyllic digester flows through heat exchangers to raise the temperature to a pasteurization temperature. The raised temperature sludge is flowed continuously through a detention tank from an input to an output, wherein sludge at the input and at the output is maintained within a pasteurization temperature range. The sludge is maintained at the elevated temperature during the flowing for a prescribed time to stabilize the sludge. After said flowing, the sludge is separated into at least biosolids and effluent.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a flow chart of a system of wastewater treatment processes, according to an embodiment of the invention;

FIG. 2 is a block diagram of a system for performing continuous flow waste water treatment according to an embodiment of this invention;

FIG. 3 is a diagram of an embodiment of a heat exchanger that may be used in the system of FIG. 2; and

FIG. 4 is a diagram of a configuration of a sludge pipe tube surrounded at its perimeter by hot ware pipe tubes in an embodiment of a heat exchanger;

FIG. 5 is a diagram of an embodiment of a detention tank for performing continuous flow pasteurization according to an embodiment of this invention; and

FIG. 6 is a cross sectional diagram of a portion of the detention tank of

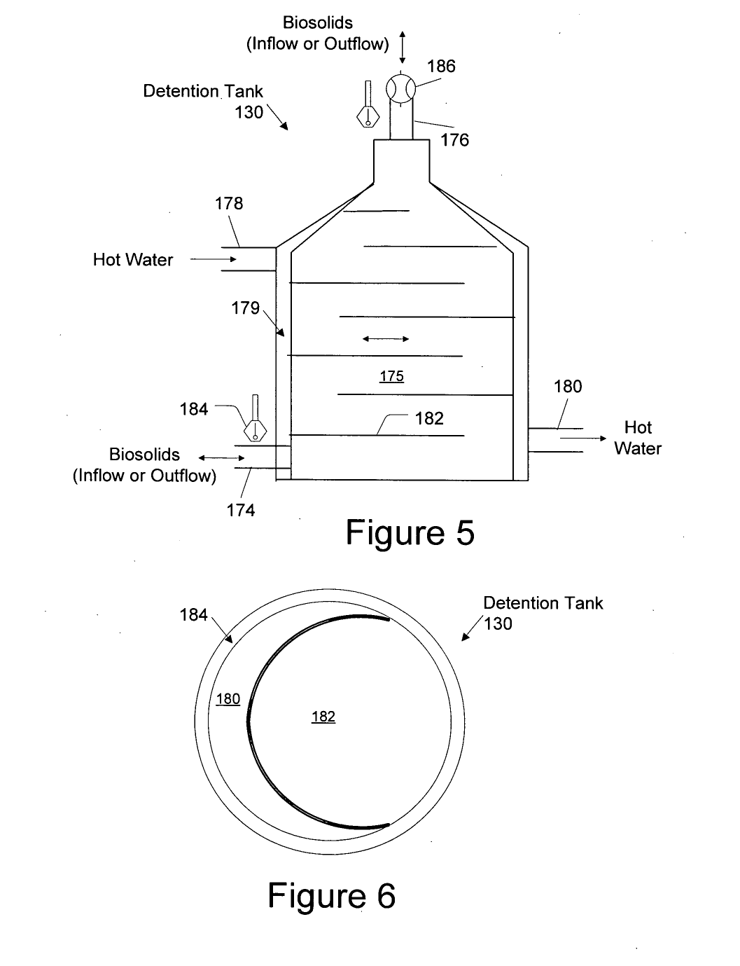

FIG. 5 showing one of the baffles located within the detention tank.

### DETAILED DESCRIPTION OF ILLUSTRATIVE EMBODIMENTS

In the following description, for purposes of explanation and not limitation, specific details are set forth, such as particular processes, devices, components, techniques, etc. in order to provide a thorough understanding of the present invention. However, it will be apparent to one skilled in the art that the present invention may be practiced in other embodiments that depart from these specific details. Detailed descriptions of well-known processes and equipment are omitted so as not to obscure the description of the present invention.

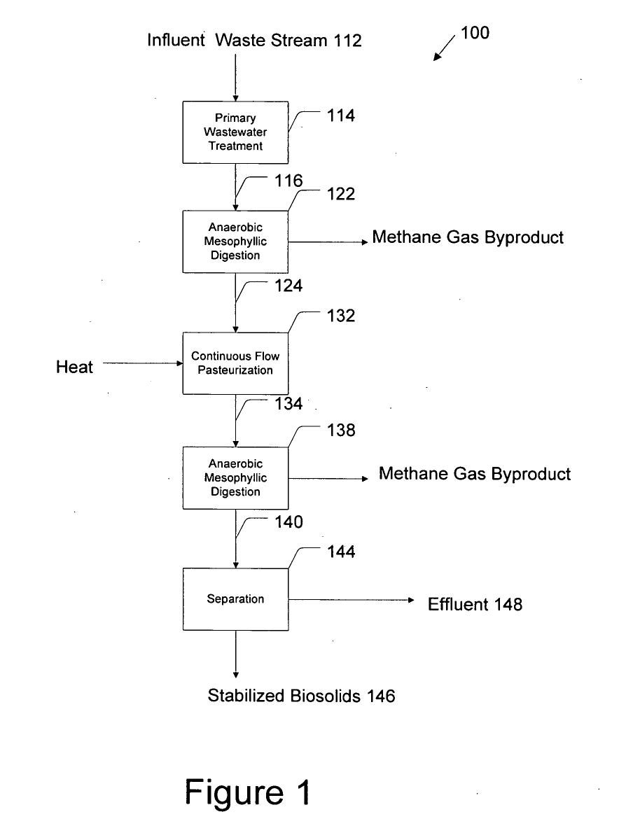

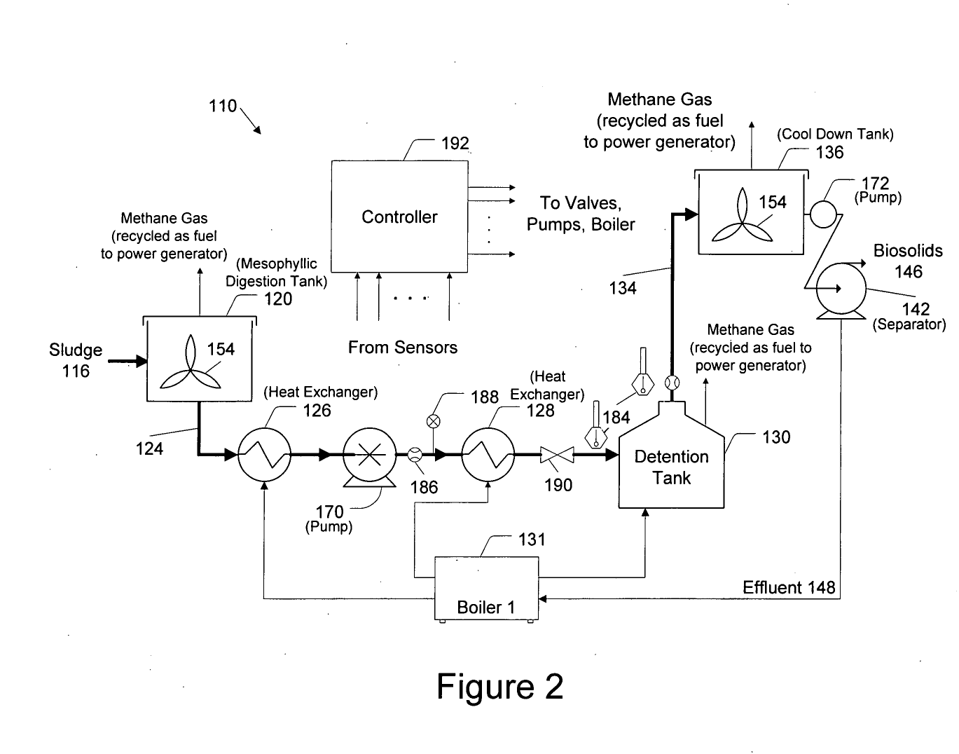

FIG. 1 shows a system 100 of wastewater treatment processes performed in series to achieve class ‘A’ biosolids, (Class ‘A’ refers to the pathogen reduction standards for sewage sludge, as specified in 40 CFR 503.32 per the Jul. 1, 2002 revision). FIG. 2 shows a system 110 of digesters, heat exchangers, and control devices that may be implemented to perform several of the processes of FIG. 1.

Referring to FIGS. 1 and 2, input to the system 100 is an influent waste stream 112, such as raw sewage, waste or sludge, that may originate, for example, from a municipal waste stream, an industrial waste stream, a food processing waste stream, a pharmaceutical waste stream or the like. The influent waste stream 112 first undergoes a primary treatment process 114 to remove a portion of the wastewater solids. In one embodiment, flocculating agents may be injected to urge minute particles to coalesce into floc, (i.e., an agglomeration of smaller particles in a gelatinous mass having the feature of being more easily removed from the liquid than the individual small particles). Screening, skimming and settling allows for a significant percentage of organic and inorganic solids to be removed. With the aid of flocculating agents, the primary treatment process may extract 50% or more of the suspended solids. In some embodiments secondary and/or tertiary treatment processes also may be performed with their sludge pumped through the digestion process.

The removed solids, a slurry of water and solids, is referred to as sludge 116. More specifically, at this point the sludge is referred to as primary, secondary or tertiary sludge, including micro-organisms, nonliving organic matter and inorganic materials. The sludge 116 from the primary, secondary or tertiary treatment processes is conveyed to a mesophyllic digester 120.

An anaerobic mesophyllic digestion process 122 occurs within the mesophyllic digester 120. Digestion is the biological decomposition of organic matter resulting in the formation of mineral and simpler organic compounds. In an anaerobic digestion process, anaerobic bacteria, growing in the absence of free oxygen, thrive by breaking down complex substances, such as the particulate matter within the sludge. To speed up the digestion, the process is performed in a mesophyllic temperature range, (i.e., 90° F. and 110° F.; approximately 20° C. to approximately 35° C.). The digester 120 is slowly fed raw wastewater sludge, so as to be mixed with existing ‘class B’ biosolids within the mesophyllic digester. Class B biosolids 124 are removed from the digester 120 at the same flow rate as the raw feed sludge 116.

The mesophyllicly treated sludge (e.g., class ‘B’ biosolids 124) is pumped through heat exchangers 126, 128 into a detention tank 130. The heat exchangers 126, 128 use hot water for heating the Class B biosolids. In an exemplary process, the class B biosolids are pumped into the heat exchanger 126 at a temperature within the range of 98° F. to 110° F. and heated to a pasteurization temperature of approximately 130° F. to 150° F. In one embodiment, hot water within a temperature range between 190° F. and 210° F. flows continuously through the heat exchangers to increase the temperature of the class B biosolids to the pasteurization temperature range of approximately 130° F. to 150° F.

As the biosolids 124 are heated an anaerobic thermophyllic digestion process occurs. As the temperature increases to approximately 130° F. to 150° F., a pasteurization process occurs. Accordingly, a pasteurization process 132 occurs in the detention tank 130. As used herein, an anaerobic thermophyllic digestion process is an anaerobic digestion process occurring at a temperature above 110° F., and typically in a range between 110° F. and 140° F. As used herein, an anaerobic pasteurization process is an anaerobic digestion process occurring at a temperature at or above 130° F., and typically in a range between 130° F. and 160° F. It is noted that the terms mesophyllic, thermophyllic and pasteurization are being used herein to describe digestion processes and are not intended to refer to an incineration process. Preferably the temperature within the detention tank is maintained to be at least 130° F., with the temperature at the inlet and outlet being continually monitored. The pasteurization process causes the cell membranes and cell walls of much of the organic matter to lyse.

In a preferred embodiment a pasteurization process is implemented to achieve class ‘A’ biosolids. To do so, the processes meet the time and temperature requirements set forth in 40 CFR 503.32 for Class A pathogen reduction. In particular, when the percent solids of the class B biosolids 124 is seven percent or higher, the temperature of the matter within the detention tank 130 is maintained at or above a specific temperature for at least a specific time period. Such minimum time and temperature are determined by equation 1 below:
D=131,700,000/10^{0.1400t} (Equation 1)
where ‘D’=time in days and ‘t’=temperature in degrees Celsius. For example, the matter in the detention tank may be maintained at a temperature of at least 50° C. for a time period of at least 20 minutes.

When the percent solids of the class B biosolids 124 are seven percent or lower, a choice of time and temperature regulations may be met. According to one option, the sludge 124 (e.g., class B biosolids) may be maintained at or above a specific temperature for a time period between 15 seconds and 30 minutes. In such case the minimum time and temperature are determined by equation 1 above. According to another option, the sludge 124 may be maintained at or above a specific temperature for a time period of at least 30 minutes. In such case the minimum time and temperature are determined by equation 2 below:
D=50,070,000/10^{0.1400t} (Equation 2)
where ‘D’=time in days and ‘t’=temperature in degrees Celsius.

In a preferred embodiment the sludge (e.g., class B biosolids) continuously flows through the detention tank 132 undergoing the pasteurization process. The flow rate through the detention tank 132 is monitored to assure that the time and temperature requirements for class ‘A’ biosolids are being met.

In an exemplary process biosolids continuously flow through the detention tank 130, so as to allow all biosolids output from the detention tank to have been maintained at a temperature of at least 150° Fahrenheit for between 15 seconds and 30 minutes, inclusive.

In another exemplary process biosolids continuously flow through the detention tank 130 at an average rate of 4 gallons per minute with the output from the detention tank having been maintained at a temperature of at least 150° Fahrenheit for between 15 seconds and 30 minutes, inclusive.

In another exemplary process biosolids continuously flow through the detention tank 130 at an average rate of 5 gallons per minute with the sludge output from the detention tank having been maintained at a temperature of at least 150° Fahrenheit for at least 20 minutes.

In another exemplary process biosolids continuously flow through the detention tank 130 with the sludge output from the detention tank having been maintained at a temperature of at least 130° Fahrenheit for at least 60 minutes.

The biosolids 134 exiting the detention tank 130 have met the time and temperature requirements to be considered class A biosolids. Thus, such biosolids 134 can be applied to land which is subject to public exposure. To reduce transportation costs a dewatering process (e.g., separation process 144) may be performed separating some of the water from the biosolids.

In some embodiments, the treated biosolids 134 flow from the detention tank 130 to a cool down tank 136 where another anaerobic mesophyllic digestion process 138 occurs. Such additional digestion is desirable because organic material is being released from the lysed cells during the pasteurization process 132. This second mesophyllic process 138 is an anaerobic process which breaks down such released organic matter. As the biosolids cool down, the anaerobic mesophyllic digestion process tends to maintain the biosolids at a temperature of approximately 90° F. to 100° F., increasing methane gas production for other energy consuming purposes. The specific amount of time that the biosolids remain in the cool down tank may vary depending on a withdrawal schedule. In some embodiments the class A biosolids remain in the tank until the tank 136 is full. In some embodiments the class A biosolids 134 remains in the cool down tank 136 for 10 to 15 days. The treated biosolids 140 then are pumped from the cool down tank 136 into a separator 142 where a water separation process 144 occurs. In one embodiment, the sludge/biosolids 140 may be spun in centrifuge fashion to separate class ‘A’ biosolids 146 from the effluent 148. Class A biosolids can be used as fertilizer and applied as a soil amendment to public areas, such as vegetable gardens, lawns, and playfields.

In some embodiments, the sludge 116 bypasses the mesophyllic digester 120 and the initial mesophyllic digestion process 122. Instead the sludge 116 is fed through heat exchangers and into the detention tank 130 to undergo the continuous flow heat treatment pasteurization process 132. Thereafter the biosolids 134 flow into the cool down tank 136 to undergo the anaerobic mesophyllic digestion process 138. However, in such embodiment, even though the heat treatment pasteurization process 132 meets the time and temperature requirements for Class A biosolids, the feeding of raw sludge prevents the digester contents from being classified as Class A biosolids. However, “exceptional quality” biosolids are output from the cool down tank 136 and extracted at the separator 142.

As used herein, the term “exceptional quality biosolids” means class ‘A’ biosolids or other biosolids that meet the time and temperature standards of pathogen reduction set forth in 40 CFR 503.32 for anaerobic digestion.

In some embodiments, energy saving measures are implemented to provide an efficient wastewater treatment process. For example, in one embodiment methane gas is recycled. One of the byproducts of the anaerobic digestion processes is methane gas. This gas is combustible and is used as a fuel to fire the hot water boiler 150. Specifically, the off-gas (e.g., methane gas) from the digestion tank 126, detention tank 130 and cool down tank 136 is collected and fed into a gas conveyance system which provides fuel to the boiler 150. In some embodiments such methane gas also fuels other. components such as a generator which powers the electrical components, the pump and the tank 126, 136 agitators.

Advantages of the continuous flow biosolids stabilization system include its relatively small footprint; destruction of volatile solids, vector attraction reduction, and pathogenic organism kill-off. Further, the pasteurization and cool down mesophyllic digestion result in increased methane gas as a byproduct. By using the methane gas byproduct for fuel, energy is conserved and operations are more efficient. The continuous flow biosolids stabilization process has been found to increase totals solids concentration in the dewatered cycle during the separation process 144.

Mesophyllic Digestion Tank 120 and Cool Down Tank 136

The digestion tank 120 and cool down tank 136 may vary in size according to the embodiment. For example, for a system which serves a residential population of 20,000 households, each of tanks 120, 136 may hold approximately 360,000 gallons. The specific volume will differ according to design and the needs of the specific community or industry being served. For an example 360,000 gallons tank, 10 inch concrete walls may be used to provide structural stability. A floating concrete lid may be included. In one embodiment a steel lid or membrane is implemented. One of skill in the art will appreciate that other lid materials may be used. An agitator 154 is mounted within the tank 120/136 to stir or agitate the contents. As the anaerobic mesophyllic digestion process 122 occurs in the tank 120 or the cool down anaerobic mesophyllic digestion process 138 occurs in the tank 136, methane gas is produced as a byproduct. The gas is mixed in with the tank contents rising as the contents are agitated. During operation the lid is sealed, allowing the gas to gather and be stored at the top of the tank. In some embodiments the gas may exit through a gas outlet. The gas may be collected for recycling or may exit to the atmosphere through a waste gas burner. The mesophyllic tank 120 includes an inlet at which the sludge 116 is received and an outlet through which class B biosolids are removed. The cool down tank 136 includes an inlet through which the pasteurized sludge enters and the stabilized biosolids exit.

Heat Exchangers 126, 128

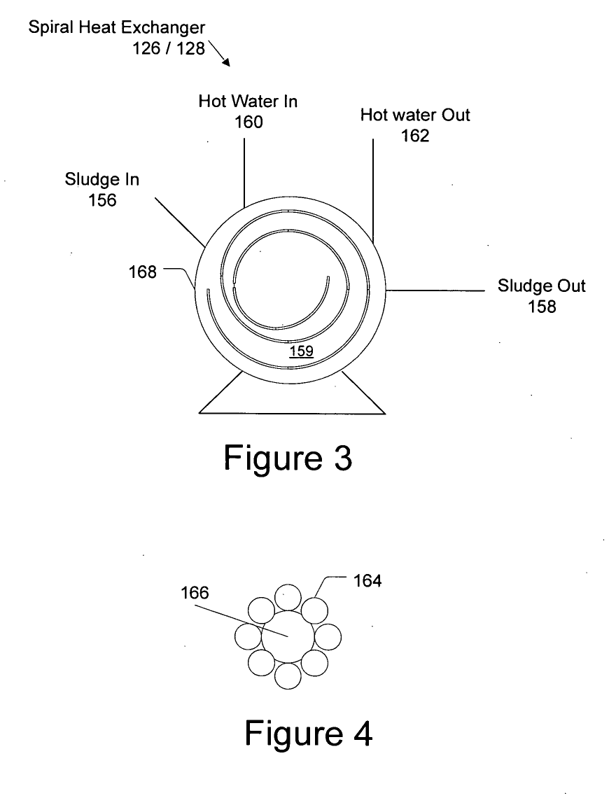

Referring to FIGS. 2 and 3, each of the spiral or tube-in-tube heat exchangers 126, 128 includes an inlet 156 at which sludge is received and an outlet 158 at which sludge is output. The sludge moves along a spiral path 159. Adjacent to the spiral path 159 along the length of the path is a hot water path. The hot water is received at an inlet 160 flows along the hot water path and exits at an outlet 162. The hot water serves as a source of heat for a heat transfer process which raises the temperature of the biosolids.

Heat exchange occurs through a wall or walls separating the sludge from the hot water, such as a steel wall. In one embodiment the hot water runs through pipe tubing 164 which contacts sludge pipe tubing 166. It is preferred that the spiral or tube-in-tube heat exchangers be housed. The sludge pipe tubing 166 and the hot water pipe tubing 164 are enclosed within the housing 168 and extend in contact with each other as the paths spiral to create a long heat exchange path within an efficient volume of space. Specifically, by spiralling the paths in a generally circular or elliptical manner the volume implemented to house a long heat exchange path is reduced to an efficient volume. Further, such spiraling serves to reduce heat losses.

In some embodiments the spiral heat exchangers include a spiral sludge path which progresses inward or outward in a concentric manner. In such a concentric spiral configuration, portions of the heat given off through the hot water pipes at the inner portions of the heat exchanger flows through concentric outward layers of sludge and hot water tubing before reaching the outer housing 168 and the ambient environment.

In a best mode embodiment two spiral heat exchangers are placed in series to further increase the heat exchange path. Experimentally it was found that spiral heat exchangers and concentric spiral heat exchangers are preferable to serpentine heat exchangers having a generally 2-dimensional path that require relatively longer paths and have difficulty achieving and maintaining the sludge at the thermophyllic temperatures implemented. For example, in an experimental configuration in which a spiral heat exchanger and serpentine heat exchanger were placed in series, it was found that the serpentine heat exchanger was not reliable for achieving and maintaining sludge at 150° F., as desired for a continuous flow stabilization process. In a preferred embodiment, spiral heat exchangers such as used in the dairy industry for pasteurizing milk have been found to be effective. In one embodiment a spiral heat exchanger type 1-H model no. 16343 as manufactured by Alfa-Laval of Scarborough, Ontario (Canada) is used, although other spiral heat exchangers or tube-in-tube heat exchangers may be used.

FIG. 4 shows an arrangement of multiple hot water pipe tubes 164 being located along the circumference of a sludge pipe tube 166. One of skill will appreciate that other configurations also may be implemented. For example, a sludge pipe tube of one diameter may be located concentrically within a how water pipe tube of larger diameter with the hot water flowing outward of the sludge pipe tube.

In the sample embodiment of a system having a 360,000 gallon digestion tank 120, a spiral heat exchange path of approximately 30 linear feet or longer may be implemented. The sludge moves along a path from the mesophyllic digestion tank 120 through the heat exchangers and a pump toward the detention tank 130. In the sample embodiment of a system having a 360,000 gallon digestion tank 120, the flow path of the sludge may have an inner diameter of approximately one inch. One of skill in the art will appreciate that flow paths having other diameters may be used.

Continuous Flow Pump

One or more pumps are implemented to pump the sludge along a path through digestion tank 120, the heat exchangers 126, 128 and detention tank 130. In one embodiment a pump 170 is located between the two spiral heat exchangers creating a pull effect from the digestion tank 120 and heat exchanger 126 and creating a push effect through the heat exchanger 128 and detention tank 130. In addition another pump 172 is located on the output side of the cool down tank 136 to pump the biosolids to land application (e.g., trucks) or the separator 142.

In one embodiment each of pumps 170, 172 may be a positive displacement pump, such as a progressive cavity pump having a consistent flow with each rotation. In a specific embodiment a Moyno® 2000 pump manufactured by Moyno Inc. of Springfield Ohio is implemented. In such pump, a single helical rotor rolling eccentrically in a double helix of the stator creates the pumping action. The rotor in conjunction with the stator forms a series of sealed cavities 180° apart. As the rotor turns, the cavities progress from the suction to the discharge. As one cavity diminishes, the opposing cavity increases at the same rate creating a pulsating-free positive displacement flow. In such embodiment the casting may be cast iron, the rotor may be alloy steel, and the stator may be nitrile, although other materials may be used. One of ordinary skill will appreciate that other pump models and types may be implemented to pump sludge through the heat exchanger 128 and detention tank 130. In one embodiment the pump is mounted on a strong, fabricated-steel base plate, which in turn is mounted on a concrete foundation, although other methods of securing the pump may be used.

The pump discharge flow varies depending on commands received from the controller. For example, in a specific process the pump may generate a flow of 20 gallons per minute with a differential pressure from discharge to intake of 60 psi for a slurry having 4% solids. The specific flow rate may be based on set points for maintaining a desired flow rate in compliance with the time and temperature requirements outlines above for treating sludge to achieve pasteurized biosolids.

In the illustrated embodiment a pump 170 is located between the two heat exchangers 126, 128. In an alternative embodiment, the pump 170 may be located after the mesophyllic digestion tank, but prior to the two heat exchangers 126, 128. In still another embodiment, one pump may be located after the mesophyllic digestion tank, but prior to the two heat exchangers 126. Another pump may be located between the two heat exchangers 126, 128. Still another pump may be located after the cool down tank 136.

Detention Tank

Referring to FIGS. 5 and 6, in one embodiment the detention tank 130 is a cylindrical pressure vessel. Class B biosolids are received at an inlet 174 and flow along a serpentine path 175 to an outlet 176. A hot water system is located at an outer periphery of the tank 130. In one embodiment the hot water system may be formed in the walls of the tank 130. In another embodiment the hot water system is in contact with the outer walls of the tank 130. In one embodiment the hot water system may include a bath. In another embodiment the hot water system may include a series of tubes. Hot water from boiler 131 is received at an inlet 178 and flows into the hot water system within the walls 179 of the tank 130 toward an outlet 180. The hot water serves to maintain a desired temperature within the tank 130. External to the hot water system, the tank 130 may be insulated and a thermal water jacket may be applied. The insulation and jacket serve to cover the tank walls and optimize the thermal heat efficiency of the tank 130/hot water system, and enable the temperature within the tank 130 to remain at a desired level.

Baffles 182 are located inside the steel vessel to force the hot Class B biosolids into the serpentine flow pattern. In particular the baffles prevent some biosolids from taking a “short circuited” path from inlet to outlet while other biosolids get pushed aside to the periphery. The baffles provide the advantage of keeping low any variance in transit time among different portions of biosolids within the tank 130. In some embodiments hot water may circulate within each of zero, one or more of the baffles. The serpentine pattern increases the path length of the biosolids through the tank 130, and thus, the amount of time that the biosolids are in the tank. In one embodiment the tank 130 has steel walls, although other materials may be used, which avoid corrosion and provide structural integrity to withstand the pressures of the flowing, viscous biosolids.

For an example system in, such as used with the 360,000 gallon mesophyllic tank 120, the detention tank may hold approximately 1,000 gallons and provide an average flow path of approximately 50 feet.

It is desirable that the biosolids spend a predefined amount of time in the vessel so as to meet the EPA criteria for a pasteurization time and temperature. Accordingly, temperature sensors 184 are located at the input and output of the tank 130 to detect temperature. In addition, a flow meter 186 measures the flow rate. One or more flow meters preferably are located along a path between the mesophyllic digester 120 and the cool down tank 136.

Control System

The system 120 includes a controller 192 which monitors, controls and records the stabilization process. The controller gathers data from several sensors, including temperature sensors 184, one or more pressure sensors 188, and one or more flow meters 186. The controller also performs calculations, such as the time and temperature calculations described above with regard to EPA rule 503.

In addition the controller receives information pertaining to the content of the digester 120 and the percent solids leaving the digester 120. The controller also may receive information pertaining to the content of the cool down tank 136. Such information is used to determine which time and temperature set points are to be implemented for a continuous flow process. As the processes may run continuously, the set points may vary depending on the biosolids characteristics, the hot water temperature, the liquid levels, et cet.

In some embodiments, an operator performs tests to monitor the content of the digester tank 120 and other tanks 130, 136. In some embodiments an operator provides set point inputs (e.g., set point minimum and maximum temperatures; set point minimum and maximum flow rates; set point minimum and maximum pressures; EPA formula to use) to the controller for the continuous flow processes.

During operation, the temperature and flow information are monitored to assure that the EPA section 503 time and temperature requirements are being met so as to provide stabilized biosolids (e.g., class A biosolids) at the output of the cool down tank 136. The controller 192 sends commands to the pump 170 and other pumps to control the flow rate throughout the continuous flow stabilization process. In addition, the controller may activate a shut-off valve 190 or pump shutdown mode to stop the flow when the required time and temperature parameters are not being met.

In addition pressure levels are monitored to assure the system is operating within a safe pressure range. In particular, it is desired to keep the sludge flowing and the pressure below a maximum tolerance level. Should the pressure exceed such maximum level, the risk of pipe breakage or another failure may increase. Pressure relief valves (not shown) are included at various locations within the system 110 which activate when pressure exceeds a threshold level. Thus, even if the automatic control system fails, pressure relief valves will activate when pressures exceed the threshold level.

There is a temperature sensor at the beginning and end of the detention vessel that sends a continuous signal to the controller 192. This temperature information is recorded within controller software and can be illustrated on a display coupled to the controller or printed as a hard copy for reference.

Following are example embodiments of the sensor devices.

Digester Temperature sensors: In one embodiment the temperature sensors 184 are iTemp Hart® TMT 182 temperature transmitters manufactured by Endress and Hauser of Greenwood, Ind. The temperature transmitter provides a resistance thermometer thermocouple with resistance and voltage sensors.

Flow rate sensor: In one embodiment the flow rate sensors 186 are part of a Proline Promag 50 electromagnetic flow measuring system having a sensor and transmitter, as manufactured by Endress and Hauser of Greenwood, Ind. The installed system has a NEMA 6P rating and NPT 0.5 inch or G 0.5 inch cable.

Pump discharge pressure sensor: In one embodiment the pressure sensor 188 is a cerabar M Hart® pressure transmitter having a current output of 4 to 20 mA and an 11.5 to 45 VDC power supply, as manufactured by Endress and Hauser of Greenwood, Ind.

One of skill will appreciate that alternative temperature sensing devices, flow metering devices and pressure sensing devices may be used in place of the devices described above.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials, processes and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A process of stabilizing biosolids, comprising:
pumping sludge through a heat exchanger to raise the temperature of the sludge into a pasteurization temperature range;
continuously flowing the raised temperature sludge along a path through a detention tank from an input to an output, wherein sludge at the input and at the output is within the pasteurization temperature range, said sludge undergoing pasteurization within the detention tank; and
after said flowing, separating the sludge into stabilized biosolids and effluent.

2. The process of claim 1,
wherein said pumping comprises pumping the sludge through a first spiral heat exchanger and a second spiral heat exchanger to raise the temperature of the sludge to at least 150 degrees Fahrenheit; and
wherein said flowing comprises flowing the raised temperature sludge through the detention tank with the sludge output from the detention tank having been maintained at a temperature of at least 150° for at least 20 minutes.

3. The process of claim 1,
wherein said pumping comprises pumping the sludge through a first spiral heat exchanger and a second spiral heat exchanger to raise the temperature of the sludge to at least 130 degrees Fahrenheit; and
wherein said flowing comprises flowing the raised temperature sludge through the detention tank with the sludge output from the detention tank having been maintained at a temperature of at least 130° for at least 60 minutes.

4. The process of claim 1, further comprising receiving the sludge into a cool down tank after said flowing and prior to said separating, wherein mesophyllic anaerobic digestion occurs within the cool down tank.

5. The process of claim 1, wherein said flowing comprises flowing the raised temperature sludge through the detention tank at an average rate of 5 gallons per minute with the sludge output from the detention tank having been maintained at a temperature of at least 150° Fahrenheit for at least 20 minutes.

6. The process of claim 1, wherein said flowing comprises continuously flowing the raised temperature sludge through the detention tank at an average rate of 4 gallons per minute with the sludge output from the detention tank having been maintained at a temperature of at least 150° Fahrenheit for between 15 seconds and 30 minutes, inclusive.

7. The process of claim 1, wherein said flowing comprises flowing the sludge along a serpentine path through the detention tank.

8. The process of claim 1, further comprising performing mesophyllic anaerobic digestion on waste matter to achieve the sludge being pumped.

9. The process of claim 1, in which said performing comprises performing mesophyllic anaerobic digestion on waste matter to achieve class B sludge.

10. The process of claim 1, in which said separating comprises separating the sludge into class A biosolids and effluent.

11. The process of claim 1, further comprising: monitoring temperatures at said input and said output of said detention tank; and controlling said pumping in response to said monitored temperatures in a manner that maintains temperature within the detention tank within said thermophyllic temperature range.

12. The process of claim 1, in which said separating comprises separating the sludge into exceptional quality biosolids and effluent.

13. A system for stabilizing biosolids, comprising:
means for continuously flowing sludge along a path;
means for elevating and maintaining temperature of the sludge within a pasteurization temperature range;
a detention tank having a channel defining a portion of said path and wherein the sludge continuously flows through the detention tank while temperature of the sludge is maintained within said pasteurization temperature range, said sludge undergoing an anaerobic thermophyllic digestion process and pasteurization while within the detention tank, said sludge being within the detention tank for an average time period of at least 131,700,000/10^{0.1400T} where T is degrees Celsius and units of said time period is days.

14. The system of claim 13, wherein said means for elevating and maintaining temperature of the sludge elevates and maintains temperature to be at least 150° F.; and wherein the sludge is maintained at least 150° F. within said detention tank for an average time period of at least 20 minutes.

15. The system of claim 13, wherein said means for continuously flowing comprises a positive displacement pump.

16. The system of claim 15, wherein said means for elevating and maintaining comprises: a first spiral heat exchanger and a second spiral heat exchanger, wherein said positive displacement pump is located in series between said first spiral heat exchanger and second spiral heat exchanger.

17. The system of claim 15, wherein said means for elevating and maintaining comprises: a first spiral heat exchanger and a second spiral heat exchanger, wherein said positive displacement pump is located along said path in series prior to said first spiral heat exchanger and second spiral heat exchanger.

18. The system of claim 13, further comprising:
a cool down tank which receives sludge from the detention tank, wherein an anaerobic mesophyllic digestion process occurs within said cool down tank; and
means for separating output from the cool down tank into stabilized biosolids and effluent.

19. The system of claim 18, wherein said elevating and maintaining means comprises a boiler, said boiler receiving and heating said effluent for use in maintaining said temperature of said sludge along a portion of said path within the pasteurization temperature range.

20. The system of claim 19, wherein said anaerobic mesophyllic process within the cool down tank generates methane gas, said methane gas serving as fuel for firing said boiler.

21. The system of claim 13 wherein class ‘A’ biosolids are output from the detention tank.

22. The system of claim 13 wherein exceptional quality are output from the detention tank.

23. The system of claim 13, further comprising a digestion tank which receives waste matter, the waste matter undergoing mesophyllic anaerobic digestion in the digestion tank, and wherein said sludge is output from said digestion tank toward said detention tank.

24. The system of claim 13, further comprising means for monitoring temperature at an input to said detention tank, mean for monitoring temperature at an output of said detention tank, and means for controlling flow rate of the sludge along said path based upon inputs received from said input temperature monitoring means and said output temperature monitoring means.
